(19) United States
(12) Patent Application Publication
(10) Pub. No.: US 2017/0068106 A1
(43) Pub. Date: Mar. 9, 2017

(54) POLARIZING PLATE, ANTI-REFLECTIVE LAMINATE, AND IMAGE DISPLAY SYSTEM

(71) Applicant: NITTO DENKO CORPORATION, Osaka (JP)

(72) Inventors: Shunsuke Murayama, Ibaraki-shi (JP); Tomohiro Yamashita, Ibaraki-shi (JP); Makiko Kimura, Ibaraki-shi (JP); Mie Nakata, Ibaraki-shi (JP)

(73) Assignee: NITTO DENKO CORPORATION, Osaka (JP)

(21) Appl. No.: 15/246,746

(22) Filed: Aug. 25, 2016

(30) Foreign Application Priority Data
Sep. 4, 2015 (JP) 2015-174724

(51) Int. Cl. G02B 27/28; G02B 5/20; G02B 5/30; G02B 1/14

(52) U.S. Cl. CPC G02B 27/286; G02B 1/14; G02B 5/208; G02B 5/3083

(57) ABSTRACT

The present invention provides a polarizing plate and an image display system capable of lowering the reflectivity and improving the visibility of a public display. The present invention relates to a polarizing plate which is disposed on a visual recognition side of an image display devise that emits circularly polarized light and which converts the circularly polarized light into linearly polarized light. The polarizing plate preferably has a first optical element and a first polarizer in this order from an incident side of the circularly polarized light. The polarizing plate preferably has a λ/4 plate disposed closer to the visual recognition side than the first polarizer.

### BACKGROUND OF THE INVENTION

Field of the Invention

The present invention relates to a polarizing plate, an anti-reflective laminate, and ah image display system.

Description of the Related Art

Image display devices represented by a liquid crystal display device and an electroluminescent display (EL display) can attain miniaturization and light weight and have excellent contrast in a bright environment. Therefore, image display devices have been often installed in mobile equipment such as a cellular phone, a portable television, a digital camera, a PDA, and a laptop computer.

Because mobile equipment is literally carried easily, a function is required of enabling its use in an environment such as outdoors with strong sunshine. For example, in order to eliminate glare outdoors, a liquid crystal display device has been proposed which has good visibility even when polarizing sunglasses are used (Patent Document 1).

### PRIOR ART DOCUMENT

### Patent Document

Patent Document 1: Japanese Patent No. 4791434

### SUMMARY OF THE INVENTION

Public displays, which are permanently installed outdoors in order to provide an advertisement or information providing services, or to form a landscape, have been drawing attention as an application development of image display devices. A public display generally has a constitution in which an image display device is installed in a case with a cover glass for visual recognition fitted therein for protecting the device from the outdoor environment so as to visually recognize an image through the cover glass. However, it has been known that such a constitution may cause a possible decrease of the visibility due to surface reflection. When a reflective liquid crystal display device (including a transflective liquid crystal display device) or an EL display is incorporated as the image display device of the public display, specular reflection of external light occurs at a reflecting plate of the reflective liquid crystal display device or metal electrodes of the EL display, so that it may cause further reduction in visibility.

In view of the above-described problems, an object of the present invention is to provide, a polarizing plate, an anti-reflective laminate, and an image display system capable of lowering the reflectivity and improving the visibility of public displays.

As a result of keen study to attain the object, a polarizing plate shown below has been found, and it has led to the completion of the present invention.

The present invention relates to a polarizing plate which is disposed on a visual recognition side of an image display devise that emits circularly polarized light and which converts the circularly polarized light into linearly polarized light.

With the polarizing plate, emission of external light reflected by the reflecting plate, metal electrodes, etc. of an image display device again to the visual recognition side (specular reflection) is suppressed by the conversion of circularly polarized light emitted from the image display device into linearly polarized light. Accordingly, the reflectivity is largely reduced to improve the visibility.

The polarizing plate preferably includes a first optical element (R1) and a first polarizer (P1) in this order from an incident side of the circularly polarized light. Accordingly, the circularly polarized light emitted from the image display device can be suitably converted into linearly polarized light. The reflection of external light can be also prevented to further improve the visibility.

The polarizing plate preferably has a λ/4 plate disposed closer to the visual recognition side than the first polarizer (P1). Because linearly polarized light emitted from the polarizing plate is converted into circularly polarized light by the λ/4 plate and the directivity of the emitted light is lessened, a screen can be visually recognized regardless of the orientation of the screen even when the screen is viewed through a polarizing means such as polarizing sunglasses.

The present invention also relates to an anti-reflective laminate including the polarizing plate and a transparent plate. When a transparent plate such as a cover glass is disposed on the visual recognition side of an image display device that emits circularly polarized light, the reflectivity increases and the visibility of a screen decreases. However, the reflectivity can be decreased and the visibility can be improved with an anti-reflective laminate having a transparent plate and the polarizing plate.

The transparent plate preferably includes a surface treatment layer having a reflectivity of 3% or less. Accordingly, the reflection can be suppressed at a surface of the transparent plate, and the visibility can be further improved.

The present invention also relates to an image display system including:

an image display device that emits circularly polarized light; and

a polarizing plate that is disposed on a visual recognition side of the image display device and that converts the circularly polarized light into linearly polarized light.

By adopting such constitution, the reflectivity can be largely reduced and good visibility can be exhibited even when the image display system is used as a public display permanently installed outdoors.

The image display device of the image display system preferably includes a cell substrate, and a second polarizer (P2) and a second optical element (R2) disposed from the cell substrate toward the visual recognition side; and

the polarizing plate preferably includes a first optical element (R1) and a first polarizer (P1) in this order from an incident side of the circularly polarized light.

By adopting the constitution, the conversion can be suitably achieved of the circularly polarized light emitted from the image display device into linearly polarized light by the polarizing plate.

The polarizing plate of the image display system preferably includes a first protective film (F1) on the visual recognition side of the first polarizer (P1); and

the image display device preferably includes a second protective film (F2) between the cell substrate and the second polarizer (P2).

Accordingly, deterioration of the polarizing plate as well as the polarizers, optical elements, etc. included in the image display device can be prevented, and the retardation of the protective films, etc. can be controlled to enhance the optical characteristics of the image display system.

The second protective film (F2) of the image display system preferably contains an ultraviolet absorbent. Accordingly, yellowing of the display part of the image display device due to ultraviolet rays can be prevented.

The image display system more preferably includes a transparent plate laminated onto the visual recognition side of the polarizing plate. Even when such transparent plate is disposed, the reflectivity of the image display system can be reduced, and good visibility can be exhibited.

The image display system preferably includes a λ/4 plate between the polarizing plate and the transparent plate. Accordingly, the image display system is applicable to polarizing sunglasses.

### BRIEF DESCRIPTION OF THE DRAWINGS

FIG. 1 shows a cross section schematically showing an image display system according to one embodiment of the present invention.

### DETAILED DESCRIPTION OF THE PREFERRED EMBODIMENTS

An image display system according to one embodiment of the present invention, and a polarizing plate and an image display device constituting the image display system will be explained below with reference to the drawings. In a part or the entirety of the drawings, parts unnecessary for the explanation are omitted, and there are parts that are enlarged or contracted to make the explanation easy. The terms used to describe positional relation such as upper and lower are simply used to make the explanation easy, and there is no intention of limiting the constitution of the present invention at all, unless otherwise specified.

### <<Image Display System>>

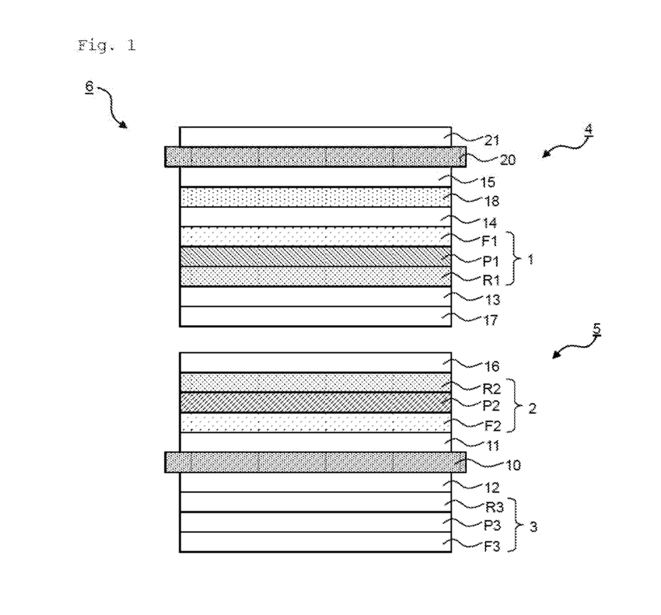

FIG. 1 is a cross section schematically showing the image display system according to one embodiment of the present invention. An image display system 6 of the present embodiment has an image display device 5 and an anti-reflective laminate 4 disposed on a visual recognition side of the image display device 5. In the image display system 6, circularly polarized light emitted from the image display device 5 is converted into linearly polarized light by a polarizing plate 1 of the anti-reflective laminate 4. Therefore, the reflectivity can be reduced, and excellent visibility can be exhibited.

### <<Anti-Reflective Laminate>>

The anti-reflective laminate 4 is disposed on the visual recognition side of the image display device 5, and has the polarizing plate 1 and a transparent plate 20 disposed closer to the visual recognition side than the polarizing plate 1. The polarizing plate 1 converts the circularly polarized light emitted from the image display device 5 to the visual recognition side into linearly polarized light. The polarizing plate 1 has a first optical element R1 and a first polarizer P1 in this order from an incident side of the circularly polarized light. The polarizing plate 1 of the present embodiment has a first protective film F1 on a visual recognition side of the first polarizer P1. The image display system 6 of the present embodiment has a λ/4 plate 18 between the polarizing plate 1 and the transparent plate 20.

### <Polarizing Plate>

As described above, the polarizing plate 1 converts the circularly polarized light emitted front the image display device 5 to the visual recognition side into linearly polarized light, and has the first optical element R1 and the first polarizer P1 in this order from the incident side of the circularly polarized light. The polarizing plate 1 may have the first protective film F1 on the visual recognition side of the first polarizer P1.

### (First Optical Element)

The first optical element R1 is not particularly limited as long as it converts circularly polarized light into linearly polarized light. In the present description and the claims of the present invention, “circularly polarized light” may include not only completely circularly polarized light but also light elliptically polarized light close to completely circularly polarized light, that is, elliptically polarized light having an ellipticity of close to 1. An example of the elliptically polarized light includes elliptically polarized light obtained when linearly polarized light is transmitted through a retardation plate in which its slow axis has an angle of 45° to the vibration direction of the linearly polarized light and its front retardation is 100 nm to 150 nm. In the present description and the claims of the present invention, any of the state of polarization, the retardation, etc. is a state of polarization, retardation, etc. at a wavelength of 550 nm when a screen is observed from the front direction that is the normal direction of the screen. It does not matter whether the circularly polarized light and the elliptically polarized light are right-handed or left-handed. Further, the state of polarization is not necessarily a completely polarized state, and may be a partially polarized state including a state of not partially polarized.

The first optical element R1 that converts circularly polarized light into linearly polarized light may be a retardation film having a retardation of 100 nm to 180 nm as described above. In this case, the retardation is preferably 110 nm to 170 nm, and more preferably 120 nm to 150 nm.

Examples of a polymer constituting the first optical element R1. to be used include cellulose derivatives having a prescribed degree of substitution disclosed in JP-A-2000-137116, etc.; copolymerized polycarbonates disclosed in WO 00/26705, etc.; and polyvinylacetal-based polymers disclosed in JP-A-2006-171235, JP-A-2006-89696, etc. A retardation adjusting agent disclosed in JP-A-2004-325523 can be also used.

A laminated retardation plate in which two or more films are laminated may be used as the first optical element R1. Examples thereof that can be suitably used include laminated retardation plates in which films are laminated so that the slow axes of the films are orthogonal to each other as disclosed in JP-A-H05-27118, JP-A-H05-27119, etc.; and laminated retardation plates in which films are laminated so that the slow axes of the films are neither parallel or perpendicular to each other as disclosed in JP-A-H05-100114, JP-A-H10-68816, JP-A-H11-149015, JP-A-2006-171713, etc.

The first optical element R1 of the image display system of the present embodiment preferably converts circularly polarized light having not only a wavelength of 550 nm but also a large bandwidth of visible light, that is, a wavelength of 400 nm to 800 nm, especially 450 nm to 750 nm, into linearly polarized light.

As described above, in order to convert circularly polarized light into linearly polarized light in the entire range of visible light, the first optical element R1 preferably has a retardation that is about ¼ of a wavelength in a large bandwidth of visible light, in other words, a retardation of about π/2 in a large bandwidth of visible light. From this viewpoint, when the retardation of an optical element R at a wavelength of (λ) nm is (Re (λ)), Re (450)/Re (550) is preferably 0.70 to 1.03, more preferably 0.73 to 1.00, and further preferably 0.75 to 0.95. Further, Re (650)/Re (550) is preferably 0.98 to 1.30, more preferably 1.02 to 1.25, and further preferably 1.05 to 1.23.

In order to allow the wavelength dependency of the retardation to fail within the above-described range, cyclic polyolefin etc. generally having a small change of retardation with wavelength (this characteristic may be referred to as “low wavelength dispersion”) can be suitably used as the polymer of the first optical element R1. Polymers having larger retardation as the wavelength becomes longer (this characteristic may be referred to as “reverse wavelength dispersion”) can be also used such as cellulose derivatives having a prescribed degree of substitution disclosed in JP-A-2000-137116, etc., copolymerized polycarbonates disclosed in WO 00/26705, etc., and polyvinylacetal-based polymers disclosed in JP-A-2006-171235, JP-A-2006-89696, etc.

The first optical element R1 may undergo a dimensional change under an environment of high temperature and high humidity. However, when the first optical element R1 is laminated to other members such as a polarizer, the amount of dimensional change may differ depending on the members, so that a stress at the film interface may be generated. The retardation may change or the orientation of the slow axis may change due to photoelastic birefringence caused by the stress. When the retardation of the first optical element R1 or the orientation of the slow axis changes, the state of polarization of light emitted from the first optical element R1 changes. Therefore, a problem may occur in which the reflectivity or the visibility of the screen observed with wearing polarizing sunglasses changes. Because the first optical element R1 of the present embodiment is disposed on the surface side (visual recognition side) of the image display device, the first optical element R1 is easily affected by the external environment. Especially when the first optical element R1 is used in a public display, the first optical element R1 is often exposed to a high-temperature and high-humidity environment. Therefore, the effect of the external environment on the first optical element R1 becomes prominent. From this viewpoint, materials having a smaller change of retardation caused by stress, that is, materials having a small photoelastic coefficient are suitably used as a material for forming the first optical element R1. The photoelastic coefficient is preferably 20×10⁻¹² m²/N or less, and more, preferably 10×10⁻¹² m²/N or less. The smaller the photoelastic coefficient is, the more preferable it is; however, it is generally 0.5×10⁻¹² m²/N or more. Among these materials, a cyclic polyolefin-based resin or an acryl-based resin can foe suitably used as the material having a small photoelastic coefficient. Further, a plurality of components with a different sign of the photoelastic coefficient may be copolymerized or mixed to effectively reduce the photoelastic coefficient.

When the first optical element R1 and the first polarizer P1 are laminated through an adhesive layer interposed therebetween without other films, materials having small moisture permeability can be suitably used as a material for forming the first optical element R1. If the moisture permeability of the first optical element R1 is excessively large, the characteristics of the first optical element R1 tend to deteriorate under a high-temperature and high-humidity environment. The moisture permeability of the first optical element R1 is preferably 10 g/m²·24 h to 150 g/m²·24 h, more preferably 30 g/m²·24 h to 120 g/m²·24 h, and further preferably 50 g/m²·24 h to 100 g/m²·24 h. The moisture permeability is generally preferably small. However, if the moisture permeability is excessively small, peeling of a pressure-sensitive adhesive may occur when the polarizer and the optical element are laminated through the pressure-sensitive adhesive, and then dried. The moisture permeability of the film is measured in accordance with a moisture permeability test (cup method) of JIS Z0208, and is expressed by the number of grams of water vapor permeating a sample having an area of 1 m² in 24 hours at 40° C. and a relative humidity difference of 90%.

Specific examples of a thermoplastic resin having small moisture permeability include a polycarbonate-based resin, a polyester-based resin, a polyarylate-based resin, polyimide-based resin, a cyclic polyolefin-based resin, a polysulfone-based resin, a polyethersulfone-based resin, an acryl-based resin, a styrene-based resin, and a maleimide-based resin. Among these, a polyimide-based resin, a cyclic polyolefin-based resin, an acryl-based resin, and a maleimide-based resin are preferably used, and a cyclic polyolefin-based resin is in particular preferable.

The polymer film can be formed by an appropriate method such as a casting method or an extruding method. The thickness of the film is generally 10 μm to 500 μm, preferably 20 μm to 300 μm, and more preferably 40 μm to 200 μm.

### (First Polarizer)

As the first polarizer P1, a polarizer can foe used which transmits polarized light as it is having a vibration plane parallel to the transmission axis among the orthogonal linearly polarized light and which selectively absorbs polarized light having a vibration plane parallel to the absorption axis.

Examples of the first polarizer P1 include films formed by allowing hydrophilic polymer films such as a polyvinyl alcohol-based film, a partially formalized polyvinyl alcohol-based film, and an ethylene-vinyl acetate copolymer-based partially saponified film to absorb dichroic substances such as iodine and a dichroic dye and uniaxially stretching the resultant; and polyene-based oriented films such as dehydration products of polyvinyl alcohol and dehydrochlorination products of polyvinyl chloride. Further, a guest-host O-type polarizer disclosed in U.S. Pat. No. 5,523,863 in which a liquid crystal composition containing a dichroic substance and a liquid crystal compound is oriented in a specific direction, an E-type polarizer disclosed in U.S. Pat. No. 6,049,428 in which a lyotropic liquid crystal is oriented in a specific direction, etc. can be used. Among these polarizers, a polarizer by a polyvinyl alcohol-based film containing iodine is preferably used from the viewpoint of having a high degree of polarization.

Any suitable thickness can be adopted as the thickness of the first polarizer P1. The thickness of the first polarizer P1 is typically 1 μm to 500 μm, and preferably 10 μm to 200 μm. When the thickness is within this range, the first polarizer P1 has excellent optical characteristics and mechanical strength.

The first polarizer P1 is disposed so as to transmit linearly polarized light emitted from the first optical element R1. From a different point of view, the first polarizer P1 is combined with the first optical element R1 to constitute a circular polarizing plate. The circular polarizing plate is provided on the visual recognition side of the image display device, so that emission of external light reflected by the reflecting plate, metal electrodes, etc. of the image display device again to the visual recognition side (specular reflection) is suppressed, and the reflectivity can be reduced. In this case, the first polarizer P1 is preferably disposed so that the angle between the slow axis direction of the first optical element R1 and the absorption axis direction of the first polarizer P1 becomes 45°±5°, more preferably 45°±3°, and further preferably 45°±1°.

The method for laminating the first optical element R1 and the first polarizer P1 is not particularly limited. For example, a pressure-sensitive adhesive can toe preferably selected and used having an acryl-based polymer, a silicone-based polymer, polyester, polyurethane, polyamide, polyether, a fluorine-based polymer, or a rubber-based polymer as a base polymer. Particularly, a pressure-sensitive adhesive such as an acryl-based pressure-sensitive adhesive can be preferably used having: excellent optical characteristics; exhibiting appropriate wettability, cohesiveness, and adhesion; and having excellent weather resistance, heat resistance, etc.

### (First Protective Film)

The polarizing plate 1 may have the first protective film F1 for the purpose of protecting the first polarizer P1. For example, a thermoplastic resin having excellent transparency, mechanical strength, thermal stability, barrier properties to moisture, etc. can be used as a material for constituting the first protective film F1. Specific examples of the thermoplastic resin include a polycarbonate-based resin, a polyvinyl alcohol-based resin, a cellulose-based resin, a polyester-based resin, a polyarylate-based resin, a polyimide-based resin, a cyclic polyolefin-based resin, a polysulfone-based resin, a polyethersulfone-based resin, a polyolefin-based resin, a polystyrene resin, a polyvinyl alcohol resin, and mixtures of these. A thermosetting resin and an ultraviolet curing-type resin of urethane-based, acrylurethane-based, epoxy-based, silicone-based, etc. can be also used. The first protective film F1 may contain at least one suitable additive. Examples of the additive include an ultraviolet absorbent, an antioxidant, a lubricant, a plasticizer, a releasing agent, a coloring inhibitor, a flame retardant, a nucleating agent, an antistatic agent, a pigment and a colorant.

When the first protective film F1 is required to have optical isotropy, that is, an in-plane retardation of 10 nm or less, preferably 5 nm or less, and more preferably 3 nm or less, a cellulose-based resin is generally used as the first protective film F1. The cellulose-based resin is preferably an ester of cellulose and aliphatic acid. Specific examples of the cellulose ester-based resin include triacetyl cellulose, diacetyl cellulose, tripropyonyl cellulose, and dipropyonyl cellulose. Among these, triacetyl cellulose is particularly preferable. Many triacetyl cellulose products are commercially available, and are advantageous in terms of easy availability and cost. Examples of the triacetyl cellulose commercial products include product names “UV-50”, “UV-80”, “SH-80”, “TD-80U”, “TD-TAC”, and “UZ-TAC” manufactured by Fujifilm Corporation; and product name “KC Series” manufactured by Konica.

A cyclic polyolefin-based resin is also preferably used as the protective film having optical isotropy. A specific example of the cyclic polyolefin-based resin is preferably a norbornene-based resin. Various types of cyclic polyolefin-based resin products are commercially available. Specific examples thereof include product names “ZEONEX” and “ZEONOR” manufactured by Zeon Corporation; product name “ARTON” manufactured by JSR Corporation; product name “TOPAS” manufactured by Ticona; and product name “APEL” manufactured by Mitsui Chemicals, Inc.

The thickness of the first protective film F1 can be appropriately determined; however, it is generally about 1 μm to 500 μm from the viewpoint of strength, workability such as handling properties, thin layer properties, etc. Particularly, the thickness is preferably 1 μm to 300 μm, and more preferably 5 μm to 200 μm.

The adhesion treatment, on the first polarizer P1 and the first protective film F1 is not particularly limited. For example, the adhesion treatment can be performed through an adhesive composed of an acryl-based polymer or a vinyl alcohol-based polymer, or an adhesive composed of at least a water-soluble crosslinking agent of a vinyl alcohol-based polymer such as boric acid, borax, glutaraldehyde, melamine, or oxalic acid. Accordingly, an adhesion layer can be formed which is not easily peeled even being affected by humidity or temperature and has excellent light transmittance and degree of polarization. The adhesive layer is formed by applying an aqueous solution of the adhesive and drying it. In the preparation of the aqueous solution, if necessary, any other additive and a catalyst such as an acid may also be added.

### <λ/4 Plate>

In the image display system 6 of the present embodiment, the λ/4 plate 18 may be provided between the polarizing plate 1 and the transparent plate 20. Because the directivity of linearly polarized light from the polarizing plate 1 is lessened by the λ/4 plate 18, a screen can be visually recognized regardless of the orientation of the screen even when the screen is viewed through a polarizing means such as polarizing sunglasses.

The retardation films described as the first optical element R1 are suitably used as the λ/4 plate 18. The λ/4 plate 18 and the polarizing plate 1, and the λ/4 plate 18 and the transparent plate 20 are laminated to each other through pressure-sensitive adhesive layers 14 and 15, respectively. The pressure-sensitive adhesives that are used to laminate the first optical element R1 and the first polarizer P1 can be suitably adopted as the pressure-sensitive adhesive for forming the pressure-sensitive adhesive layers 14 and 15.

### <Transparent Plate>

The transparent plate 20 is a member fitted in a case for protecting the image display device 5 from the external environment. An image displayed in the image display device 5 can be visually recognized through the transparent plate 20. A material for forming the transparent plate 20 is not particularly limited as long as the material has transparency, strength, and resistance to environment. Suitably, glass and plastic materials of optical member grade can be used.

The thickness of the transparent plate 20 can be also appropriately selected depending on the characteristics required. The thickness of the transparent plate 20 is generally 0.5 mm to 20 mm, and preferably 0.5 mm to 5 mm.

A surface treatment layer 21 having a reflectivity of 3% or less is preferably provided on the visual recognition side of the transparent plate 20. The reflectivity of the surface treatment layer 21 is preferably 3% or less, and more preferably 1% or less. The constitution of the surface treatment layer 21 is not particularly limited, and for example, a single layer or multiple layers of two or more layers can be adopted. In general, the optical film thickness (product of the refractive index and the thickness) of a surface treatment layer is preferably adjusted so that opposite phases of incident light and reflected light is canceled to thereby exhibit an anti-reflective function. For example, allow refractive index layer having a refractive index of about 1.35 to 1.55 is formed as the surface treatment layer so that the optical film thickness becomes 120 nm to 14 0 nm to lower intensity of the reflected light.

A multilayered laminate having layers each with a different refractive index is suitably used as the surface treatment layer 21. The optical film thickness (product of the refractive index and the thickness) of each layer of the multilayered laminate is appropriately adjusted, so that the reflectivity in a desired wavelength range is decreased. Examples of the material that can form each layer of the multi layered laminate include silicon oxide (SiO₂) and magnesium fluoride (MgF₂) as a low refractive index material having a refractive index of about 1.35 to 1.55; and titanium oxide (TiO₂), niobium oxide (Nb₂O₃), indium tin oxide (ITO), antimony tin oxide (ATO), and ZrO₂-TiO₂ as a high refractive index material having a refractive index of about 1.60 to 2.20. In addition to the low refractive index layer and the high refractive index layer, a thin film composed of titanium oxide or a mixture of the low refractive index material and the high refractive index material (a mixture of titanium oxide and silicon oxide) may be formed as a medium refractive index layer having a refractive index of about 1.50 to 1.85.

Because the surface treatment layer 21 is often attached to the outermost surface of the image display system 6, the surface treatment layer 21 is easily contaminated by the external environment. The contamination becomes prominent more easily than the case of a simple transparent plate such that particularly familiar contaminants such as fingerprints, dirt from the hand, sweat, and a hair styling product can easily adhere, and the adhesion of these contaminants makes the surface reflectivity change or the adhering contaminants are observed appearing in white, so that the displayed content becomes unclear. In this case, a silane-based compound containing a fluorine group, an organic compound containing a fluorine group, etc. can be formed on the surface treatment layer 21 to give functions related to anti-adhesion and easy removability.

### (Other Constitution)

A hard coat layer 17 may be provided on the rear side of the polarizing plate 1 of the anti-reflective laminate 4 for preventing scratches and stains onto the polarizing plate 1. The hard coat layer 17 may be provided directly on the polarizing plate 1 or may be laminated to the polarizing plate 1 as an independent optical layer through a pressure-sensitive layer 13 interposed therebetween.

The hard coat layer 17 preferably has excellent hard coat properties, sufficient strength after the formation of coating layer, and excellent light transmittance. Examples of the resin for forming the hard coat layer 17 include a thermosetting resin, a thermoplastic resin, an ultraviolet curing-type resin, an electron beam curing-type resin, and a two-liquid mixing-type resin. Among these, an ultraviolet curing-type resin is preferable which can effectively form a hard coat layer with a simple processing operation in the curing treatment by irradiation with ultraviolet rays.

Examples of the ultraviolet curing-type resin are various types of ultraviolet curing-type resins such as polyester-based resin, acryl-based resin, urethane-based resin, amide-based resin, silicone-based resin, and epoxy-based resin, and include ultraviolet curing-type monomer, oligomer, polymer, etc. Examples of the ultraviolet curing-type resin that is preferably used include resins having ultraviolet polymerizable functional groups. Among these, the ultraviolet curing-type resin is preferably one containing two or more, particularly 3 to 6 functional groups and an acryl-based monomer or oligomer component. The ultraviolet curing-type resin is blended with an ultraviolet polymerization initiator.

The method for forming the hard coat layer 17 is not particularly limited, and an appropriate method can be adopted. For example, in the case that the hard coat layer 17 is provided directly on the polarizing plate 1, a method can be adopted of applying, onto the polarizing plate 1, a resin composition for forming the hard coat layer, drying the composition, and then curing the composition. The resin composition can be applied by using an appropriate manner such as fountain coating, die coating, casting, spin coating, fountain metering, and gravure coating. Prior to the application, the resin composition is preferably diluted with a general solvent such as toluene, ethyl acetate, butyl acetate, methyl ethyl ketone, methyl isobutyl ketone, isopropyl alcohol, or ethyl alcohol to be formed into a solution. The thickness of the hard coat layer 17 is not particularly limited; however, it is preferably about 0.5 μm to 30 μm, and especially preferably about 3 μm to 15 μm. In the case that the hard coat layer 17 is laminated to the polarizing plate 1 as an independent optical layer through the pressure-sensitive layer 13 interposed therebetween, a method can be adopted of applying, onto a base material such as a triacetyl cellulose film, a resin composition for forming a hard coat cured film, drying the composition, curing the composition, and forming the hard coat cured film, followed by laminating the face of the base material opposite to the hard coat cured film with the pressure-sensitive layer 13. Accordingly, in this case, a laminate of the base material and the hard coat cured film forms the hard coat layer 17.

### <<Image Display Device>>

A display device such as a liquid crystal display device, a plasma display panel, an electroluminescence display, or a cathode display device can be adopted as the image display device 5. The anti-reflective laminate 4 having the polarizing plate 1 that converts circularly polarized light into linearly polarized light is suitably used as an optical element for preventing reflection of an electroluminescence display and a reflective liquid crystal display device in which the specular reflection of the external light can easily occur.

A liquid crystal display device as the image display device 5 has a cell substrate 10, a polarizing plate 2 (also referred to as “upper polarizing plate” below for convenience) disposed on a visual recognition side of the cell substrate 10 (the upper side of the cell substrate 10 in FIG. 1), and a polarizing plate 3 (also referred to as “lower polarizing plate/” below for convenience) disposed on a rear side of the cell substrate 10 (the lower side of the cell substrate 10 in FIG. 1). The polarizing plates 2 and 3 are laminated to the cell substrate 10 through pressure-sensitive adhesive layers 11 and 12 interposed therebetween, respectively.

The upper polarizing plate 2 has a second polarizer P2 and a second optical element R2 disposed closer the visual recognition side than the polarizer. The optical element R2 converts linearly polarized light emitted from the second polarizer P2 to the visual recognition side into circularly polarized light. The image display device 5 of the present embodiment further has a second protective film F2 between the cell substrate 10 and the second polarizer P2. The lower polarizing plate 3 has a third optical element R3 and a third polarizer P3 disposed closer to the rear side than the third optical element P3 in this order, and a third protective film F3 on the rear side of the third polarizer P3.

The corresponding elements or layers in the anti-reflective laminate 4 are suitably adopted for each of the elements or the layers in the liquid crystal display.

The second protective film F2 preferably contains an ultraviolet absorbent. Specific examples of the ultraviolet absorbent include a conventionally known oxybenzophenone-based compound, a benzotriazole-based compound, a salicylic acid ester-based compound, a benzophenone-based compound, cyanoacrylate-based compound, a nickel complex salt-based compound, and a triazine-based compound. Examples of the method for adding the ultraviolet absorbent to the second protective film F2 include a method of containing the ultraviolet absorbent in the second protective film F2 and a method of laminating a layer containing the ultraviolet absorbent as a constituting layer of the second protective film F2. The content of the ultraviolet absorbent in the second protective film F2 may be appropriately adjusted so as to obtain the targeted ultraviolet prevention effect.

A liquid crystal display device will be explained in detail below as the image display device 5 of the present embodiment. If the liquid crystal display device has the second optical element R2, the second polarizer P2, and the ceil substrate 10 as in FIG. 1, other constituents are not particularly limited. The liquid crystal display device can be formed in accordance with a conventional method. Generally, the constituting parts such as a cell substrate; polarizing plates; optical layers such as a retardation film, a viewing angle expansion film, a diffusion plate, an antiglare layer, an anti-reflective film, a protective film, a prism array, a lens array sheet, a reflective plate, a transflective plate, and an brightness improving film; and an illumination system as necessary are appropriately assembled, a driving circuit is incorporated, etc. to form the liquid crystal display device.

One aspect of the liquid crystal display device of the present embodiment is a reflective liquid crystal display device in which a reflective plate or a reflective polarizing plate, etc. is provided on the side opposite to the rear side of the cell substrate, that is, the side where the second polarizer is provided, to use external light. Another embodiment is a transmission type liquid crystal display device in which the third polarizer (or a polarizing plate having a protective film(s) on one surface or both surfaces of the polarizer) and a light source are provided further on the side opposite to the side where the second polarizer of the cell substrate is provided. A transflective liquid crystal display device that uses both light source and external light is also a preferable embodiment.

The reflective polarizing plate can be used in a type of a liquid crystal display device (reflective liquid crystal display device) in which the polarizing plate is disposed on the rear side of the cell substrate and reflects incident light (external light) from the visual recognition side to display an image. This reflective polarizing plate has advantages of being capable of reducing the thickness of the liquid crystal display device, because a light source such as back light is omitted from being built-in.

The reflective polarizing plate can be produced by a conventionally known method such as a method of forming a reflective plate composed of a metal, etc. on one surface of the polarizing plate. A specific example thereof includes a reflective polarizing plate formed in a way that one surface (exposed surface) of the transparent protective layer in the polarizing plate is matted as necessary and a metal foil or a deposition film composed of a reflective metal such as aluminum is formed on this surface as the reflective plate.

Another example is a reflective polarizing plate formed in a way that fine particles are contained in each type of transparent resins to make the surface of the transparent protective layer have an uneven microstructure and a reflective plate on which the uneven microstructure is reflected is formed on the surface. The reflective plate whose surface has the uneven microstructure has advantages of diffusing incident light by diffused reflection to prevent the directivity and the glare and suppress uneven brightness. This reflective plate can be directly formed on the uneven surface of the transparent protective layer as the metal foil or a metal deposition film with a conventionally known method such as a deposition method or a plating method including vacuum deposition, ion plating, or sputtering.

The transflective polarizing plate is a reflective polarizing plate having a transflective plate instead of the reflective plate. An example of the transflective plate includes a half mirror which reflects light at the reflective layer and transmits the light.

The transflective polarizing plate is normally provided on the rear side of the cell substrate. The transflective polarizing plate can be used in a liquid crystal display device, etc. of a type in which the polarizing plate reflects incident light from the visual recognition side (display side) to display an image when used in a relatively bright environment, and a built-in light source such as back light built in the back side of the transflective polarizing plate is used to display an image when used in a relatively dark environment. That is, the transflective polarizing plate is useful for forming a liquid crystal display device, etc. of a type capable of saving an energy for using a light source such as back light under a bright environment, and using the built-in light source under a relatively dark environment.

Examples of the cell substrate include various types of cell substrates of twisted nematic (TN) mode, super twisted nematic (STN) mode, electrically-controlled birefringence (ECB) mode, vertical alignment (VA) mode, in-plane switching (IPS) mode, fringe field switching (FFS) mode, optically compensated bend (OCB) mode, hybrid-aligned nematic (HAN) mode, surface-stabilized ferroelectric liquid crystal (SSFLC) mode, and anti-ferroelectric liquid crystal (AFLC) mode.

### EXAMPLES

The present invention will be explained with reference to examples below; however, the present invention is not limited to the examples shown below.

### <Production of Polarizing Plate for Anti-Reflective Laminate>

Polarizing plates 1A and 1B for anti-reflective laminate for pasting to an image display device were produced in the following procedure.

### (Polarizing Plate 1A)

A polyvinyl alcohol (PVA) film having a thickness of 60 μm (product name “VF-PE #6000” manufactured by Kuraray Co., Ltd.) was stretched to 3 times between rolls each having a different speed ratio while being dyed in a 0.3 wt % iodine solution at 30° C. for 1 minute. Then, the film was further stretched so that a total stretching ratio became 6 times while being immersed in an aqueous solution containing 4 wt % boric acid and 5 wt % potassium iodide at 60° C. for 0.5 minutes. Next, the stretched film was immersed in an aqueous solution containing 3 wt % potassium iodide at 30° C. for 10 seconds for cleaning, and dried at 50° C. for 4 minutes to obtain a PVA film having a thickness of 23 μm which could be used as a polarizable layer.

A ¼ wavelength retardation layer having a thickness of 47 μm (product name “diagonally stretched ZEONOR film (ZD12-141083)” manufactured by Zeon Corporation) was laminated to one surface of the PVA film by a polyvinyl alcohol-based adhesive . The slow axis of the ¼ wavelength retardation layer had an angle of 45 degrees to the stretching direction (absorption axis direction) of the PVA film.

A saponified ultraviolet absorbent-containing triacetyl cellulose (TAG) film having a thickness of 40 μm (product name “TAG film KC4UY” manufactured by Konica Minolta Opto Products Co., Ltd.) was laminated to the other surface of the PVA film by a polyvinyl alcohol-based adhesive to obtain a laminate.

An anti-reflective layer was provided on the ¼ wavelength retardant layer side of the obtained laminate through a pressure-sensitive layer having a thickness of 20 μm interposed therebetween to produce a polarizing plate 1A.

### (Polarizing Plate 1B)

A saponified ultraviolet absorbent-containing TAG film having a thickness of 40 μm (product name “TAG film KC4UY” manufactured by Konica Minolta Opto Products Co., Ltd.) was laminated to both surfaces of a PVA film that was same as the polarizing plate 1A by a polyvinyl alcohol-based adhesive to obtain a laminate.

An anti-reflective layer was provided on one of the surfaces of the obtained laminate through a pressure-sensitive adhesive layer having a thickness of 20 μm interposed therebetween to produce a polarizing plate 1B.

### <Production of Polarizing Plate for Image Display Device>

Upper polarizing plates 2A and 2B and a lower polarizing plate 3 for pasting to a cell substrate of an image display device were produced in the following procedure.

### (Upper Polarizing Plate 2A)

A ¼ wavelength retardation layer having a thickness of 47 μm (product name “diagonally stretched ZEONOR film (ZD12-141083)” manufactured by Zeon Corporation) was laminated to one surface of a PVA film that was same as the polarizing plate 1A by a polyvinyl alcohol-based adhesive. The slow axis of the ¼ wavelength retardation layer had an angle of 45 degrees to the stretching direction (absorption axis direction) of the PVA film.

A saponified ultraviolet absorbent-containing TAC film having a thickness of 40 μm (product name: “KC4DR-1” manufactured by Fujifilm Corporation) was laminated to the other surface of the PVA film by a polyvinyl alcohol-based adhesive to obtain a laminate.

An anti-reflective layer was provided on the ¼ wavelength retardant layer side of the obtained laminate through a pressure-sensitive layer having a thickness of 20 μm interposed therebetween to produce a polarizing plate 2A.

### (Upper Polarizing Plate 2B)

A saponified TAC film having a thickness of 60 μm (product name “TAC film KC6UA” manufactured by Konica Minolta Opto Products Co., Ltd.) was laminated to one surface of a PVA film that was same as the polarizing plate 1A by a polyvinyl alcohol-based adhesive.

A saponified TAG film having a thickness of 40 μm (product name “KC4DR-1” manufactured by Fujifilm Corporation) was laminated to the other surface of the PVA film by a polyvinyl alcohol-based adhesive to obtain a laminate.

An anti-reflective layer was provided on the KC6UA side of the obtained laminate through a pressure-sensitive layer having a thickness of 20 μm interposed therebetween to produce a polarizing plate 2B.

### (Lower Polarizing Plate 3)

A saponified TAC film having a thickness of 60 μm (product name “TAC film KC6UA” manufactured by Konica Minolta Opto Products Co., Ltd.) was laminated to one surface of a PVA film that was same as the polarizing plate 1A by a polyvinyl alcohol-based adhesive.

A saponified TAG film having a thickness of 40 μm (product name “KC4DR-1” manufactured by Fujifilm Corporation) was laminated to the other surface of the PVA film by a polyvinyl alcohol-based adhesive to produce a polarizing plate 3.

### <Production of Anti-Reflective Laminate>

An anti-reflective laminate was produced in the following procedure.

### (Anti-Reflective Laminate A)

The polarizing plate 1A produced above was laminated to one surface of a soda lime glass plate (270 mm×320 mm×thickness 1.1 mm) manufactured by Matsunami Glass Ind., Ltd. with the TAC film side facing the glass plate through an acryl-based pressure-sensitive adhesive interposed therebetween. A TAC film with anti-reflective layer (product name “DSG17V1” manufactured by Dai Nippon Printing Co., Ltd.) was laminated to the other surface of the glass plate through an acryl-based pressure-sensitive adhesive interposed therebetween.

### (Anti-Reflective Laminate B)

The polarizing plate 1A produced above was laminated to one surface of a soda lime glass plate (270 mm×320 mm×thickness 1.1 mm) manufactured by Matsunami Glass Ind., Ltd. with the TAC film side facing the glass plate through an acryl-based pressure-sensitive adhesive interposed therebetween. A TAC film with anti-reflective layer (product name “DSG03” manufactured by Dai Nippon Printing Co., Ltd.) was laminated to the other surface of the glass plate through an acryl-based pressure-sensitive adhesive interposed therebetween.

### (Anti-Reflective Laminate C)

A ¼ wavelength retardation layer having a thickness of 47 μm (product name “diagonally stretched ZEONOR film (ZD12-141083)” manufactured by Zeon Corporation) was laminated to one surface of a soda lime glass plate (270 mm×320 mm×thickness 1.1 mm) manufactured by Matsunami Glass Ind., Ltd. through an acryl-based pressure-sensitive adhesive interposed therebetween. The polarizing plate 1A produced above was laminated to the ¼ wavelength retardant layer with the TAC film side facing the glass plate through an acryl-based pressure-sensitive adhesive interposed therebetween. A TAC film with anti-reflective layer (product name “DSG17V1” manufactured by Dai Nippon Printing Co., Ltd.) was laminated to the other surface of the glass plate through an acryl-based pressure-sensitive adhesive interposed therebetween.

### (Anti-Reflective Laminate D)

A TAC film with anti-reflective layer (product name “DSG17V1” manufactured by Dai Nippon Printing Co., Ltd.) was laminated to one surface of a soda lime glass plate (270 mm×320 mm×thickness 1.1 mm) manufactured by Ma tsunami Glass Ind., Ltd. through an acryl-based pressure-sensitive adhesive interposed therebetween. A polarizing plate was not laminated to the other surface of the glass plate.

### (Anti-Reflective Laminate E)

The polarizing plate 1B produced above was laminated to one surface of a soda lime glass plate (270 mm×320 mm×thickness 1.1 mm) manufactured by Ma tsunami Glass Ind., Ltd. with the TAC film side facing the glass plate through an acryl-based pressure-sensitive adhesive interposed therebetween. A TAC film with anti-reflective layer (product name “DSG17V1” manufactured by Dai Nippon Printing Co., Ltd.) was laminated to the other surface of the glass plate through an acryl-based pressure-sensitive adhesive interposed therebetween.

### <Production of Image Display Device>

A polarizing plate was peeled from a liquid crystal panel “BRAVIA KDL-46W920A” manufactured by Sony Corporation, and the polarizing plate produced above was laminated thereto with a constitution shown in Table 1 by a hand roller to produce an image display device.

### <Evaluation of Reflectivity>

The image display device was placed on a reflective plate, and the anti-reflective laminate was placed thereon with the glass plate being on the visual recognition side. In this condition, the total reflectivity was measured with a spectral colorimeter (product name “CM-2600d” manufactured by Konica Minolta, Inc.). The case in which the reflectivity was 2% or less was evaluated as “⊙”, the case in which the reflectivity was more than 2% and 3% or less was evaluated as “◯”, and the case in which the reflectivity was more than 3% was evaluated as “x”. The results are shown in Table 1.

TABLE 1

| | | | | | Comparative | Comparative | Comparative |
|---|---|---|---|---|---|---|---|
| | | Example 1 | Example 2 | Example 3 | Example 1 | Example 2 | Example 3 |
| Anti-Reflective | | A | B | C | D | E | A |
| Laminate | | Polarizing | Polarizing | λ/4 Plate | None | Polarizing | Polarizing |
| | | Plate 1A | Plate 1A | Polarizing | | Plate 1B | Plate 1A |
| | | | | Plate 1A | | | |
| Image Display | Upper | Polarizing | Polarizing | Polarizing | Polarizing | Polarizing | Polarizing |
| Device | Side | Plate 2A | Plate 2A | Plate 2A | Plate 2A | Plate 2A | Plate 2B |
| | Lower | Polarizing | Polarizing | Polarizing | Polarizing | Polarizing | Polarizing |
| | Side | Plate 3 | Plate 3 | Plate 3 | Plate 3 | Plate 3 | Plate 3 |

| | | | | | | |
|---|---|---|---|---|---|---|
| Reflectivity [%] | 1.50 | 2.60 | 1.50 | 7.33 | 7.30 | 7.40 |
| Evaluation | ⊙ | ○ | ⊙ | × | × | × |

In Examples 1 to 3, the reflectivity was suppressed, and the display was confirmed very satisfactorily. Because the λ/4 plate was disposed on the visual recognition side of the polarizing plate of the anti-reflective laminate in Example 3, the display was also visually recognized through polarizing sunglasses. On the other hand, because the reflectivity was high in Comparative Examples 1 to 3, the reflection was strong and it was difficult to see the display.

What is claimed is:

1. A polarizing plate which is disposed on a visual recognition side of an image display device that emits circularly polarized light and which convert s the circularly polarized light into linearly polarized light.

2. The polarizing plate according to claim 1, comprising a first optical element and a first polarizer in this order from an incident side of the circularly polarized light.

3. The polarizing plate according to claim 2, comprising a λ/4 plate disposed closer to the visual recognition side than the first polarizer.

4. An anti-reflective laminate comprising the polarizing plate according to claim 1 and a transparent plate.

5. The anti-reflective laminate according to claim 4, where in the transparent plate comprises a surface treatment layer having a reflectivity of 3% or less.

6. An image, display system comprising:
an image display device that emits circularly polarized light; and
a polarizing plate which is disposed on a visual recognition side of the image display device and which converts the circularly polarized light into linearly polarized light.

7. The image display system according to claim 6, wherein the image display device comprises a cell substrate, and a second polarizer and a second optical element disposed from the cell substrate toward the visual recognition side; and
the polarizing plate comprises a first optical element and a first polarizer in this order from an incident side of the circularly polarized light.

8. The image display system according to claim 7, wherein the polarizing plate comprises a first protective film on the visual recognition side of the first polarizer; and
the image display device comprises a second protective film between the cell substrate and the second polarizer.

9. The image display system according to claim 8, wherein the second protective film contains an ultraviolet absorbent.

10. The image display system according to claim 6, comprising a transparent plate laminated onto the visual recognition side of the polarizing plate.

11. The image display system according to claim 10, comprising a λ/4 plate between the polarizing plate and the transparent plate.
